(19) United States
(12) Patent Application Publication
(10) Pub. No.: US 2011/0147673 A1
(43) Pub. Date: Jun. 23, 2011

(54) METHOD OF MANUFACTURING COMPOSITE CONDUCTING FIBRES, FIBRES OBTAINED BY THE METHOD, AND USE OF SUCH FIBRES

(75) Inventors: Patrice Gaillard, Hagetaubin (FR); Patrick Piccione, Berkshire (GB); Pierre Miaudet, Pau (FR); Philippe Poulin, Talence (FR); Carine Perrot, Liverdy En Brie (FR)

(73) Assignee: ARKEMA FRANCE, Colombus (FR)

(21) Appl. No.: 12/999,499

(22) PCT Filed: Jun. 25, 2009
(86) PCT No.: PCT/FR2009/051225

§ 371 Date: Mar. 4, 2011

(30) Foreign Application Priority Data
Jul. 3, 2008 (FR) 0854512

(51) Int. Cl. H01B 1/24; H01B 1/12; H01B 1/22; B82Y 30/00; B82Y 40/00

(52) U.S. Cl. 252/511; 252/500; 252/514; 252/513; 252/515; 252/512; 252/519.33; 977/742; 977/840

(57) ABSTRACT

The invention relates to a method of manufacturing fibres made of a composite based on a thermoplastic polymer and conducting or semiconducting particles, which includes a heat treatment, said heat treatment consisting in heating the composite, by progressively raising the temperature, having the effect of improving the conducting properties of the fibres obtained or of making the initially insulating fibres conducting. The invention also relates to the conducting fibres thus obtained and in particular to polyamide fibres and carbon nanotubes.

The invention relates to a process for manufacturing conductive composite fibers such as conductive fibers based on a thermoplastic polymer and on conductive or semiconductive particles, the particles possibly being, in particular, carbon nanotubes (CNTs).

The invention also relates to composite conductive fibers obtained from said process and the uses of such fibers.

Carbon nanotubes are known and used for their excellent properties of electrical and thermal conductivity and also their mechanical properties. Thus, they are increasingly used as additives in order to provide materials, especially those of macromolecular type, with these electrical, thermal and/or mechanical properties.

It is known that the filler content necessary for the electrical conduction of composites greatly decreases with the increase in the aspect ratio of the conductive particles, which is why it is preferred to use carbon nanotubes compared to carbon black or another form of carbon-based material. Reference may be made to the prior art constituted by the following documents: WO 03/079375; D. Zhu, Y. Bin, M. Matsuo, “Electrical conducting behaviors in polymeric composites with carbonaceous fillers”, J. of Polymer Science Part B, 45, 1037, 2007; Y. Bin, M. Mine, A. Koganemaru, X. Jiang, M. Matsuo, “Morphology and mechanical and electrical properties of oriented PVA-VGCF and PVA-MWNT composites”, Polymer, 47, 1308, 2006).

However, the percolation threshold increases with the orientation of the carbon nanotubes as appears in the following document: F. Du, J.E. Fischer, K.I. Winey, “Effect of nanotube alignment on percolation conductivity in carbon nanotube/polymer composite”, Physical Review B, 72, 121404, 2005. Indeed, the process used for manufacturing composite fibers which consists in extruding the mixture through a die, may induce an alignment of the carbon nanotubes parallel to the axis of the fiber.

In any case, the procedures for processing fibers such as extrusion and/or drawing may induce an orientation of the conductive particles in the axis of the fibers.

Thus, the CNT concentration necessary for achieving the percolation threshold of a composite in the form of a fiber may range up to one order of magnitude higher than in the form of non-oriented films or fibers.

The consequence of this orientation phenomenon is that it is necessary to increase the content of CNTs in order to render the composites conductive, especially when these composites are used in the form of fibers. These results are described in detail in the publication by: R. Andrews, D. Jacques, M. Minot, T. Rantell, entitled “Fabrication of carbon multiwall nanotube/polymer composites by shear mixing”, Macromolecular Materials and Engineering, 287, 395, 2002.

Among the processes for manufacturing composite fibers, reference may be made to patent EP 1 181 331. This patent describes a process for manufacturing a composite based on a thermoplastic polymer, the mechanical properties of which are reinforced by the presence of nanotubes. In this process, a mixture of thermoplastic polymer and of CNTs is produced, then the mixture is drawn at the melting temperature of the polymer, then it is drawn again in the solid state (at low temperature). Fibers may thus be obtained from this material made of reinforced polymer.

Reference may also be made to the process for manufacturing composite fibers described in international application WO 2001/063028. According to this process, the dispersion of CNTs in a solvent is produced, that is injected via a nozzle into a coagulation agent constituted of a polymer, then a drawing operation and an annealing are possibly carried out.

Unfortunately in this case, initially conductive fibers become less conductive following significant drawing as is demonstrated by R. Haggenmueller, H. H. Gommans, A. G. Rinzler, J. E. Fischer, K. I. Winey, in the article entitled “Aligned single-wall carbon nanotubes in composites by melt processing methods”, published in Chemical Physics Letters, 330, 219, 2000.

Indeed, the drawing step carried out after formation of a fiber, when it is 50% and above, degrades the conductivity properties, of course in the case where the composite or the fibers made of composite have conductive properties.

The objective of the present invention is to overcome the drawbacks of the various processes cited in order to improve the electrical properties of conductive composite fibers or to make initially insulating fibers conductive.

This objective is achieved owing to the process for manufacturing composite fibers according to which the heat treatment step is carried out with a temperature that undergoes a gradual rise.

For this purpose, one subject of the invention is more particularly a process for manufacturing fibers constituted of a composite based on a thermoplastic polymer and on conductive or semiconductive particles, comprising a heat treatment, said heat treatment consisting of heating the composite produced with a gradual rise in the temperature.

The gradual rise in temperature is achieved by a ramp preferably of less than 50° C. per minute, preferably of less than 30° C. per minute, preferably of less than 10° C. per minute.

Preferably, the gradual rise in temperature is achieved by a ramp of 5° C. per minute.

The heating temperature necessary is greater than or equal to the glass transition temperature of the thermoplastic polymer. The heating temperature reaches or is greater than the melting temperature of the thermoplastic polymer when the content of conductive particles in the composite is reduced.

The heat treatment may be carried out on the composite during spinning and/or after spinning, the material constituting the fiber formed then being annealed.

In the case where the treatment is carried out after spinning, a post-heat treatment is carried out, the heating temperature applied being referred to as the annealing temperature.

Whatever the choice, during or after spinning, the heat treatment carried out with a gradual rise in the heating or annealing temperature has the effect of improving the conductive properties of the fibers obtained or of rendering fibers that are initially insulating conductive without the drawbacks of the heat treatments proposed to date and without actually giving rise to a degradation of the macroscopic structure of the fibers.

The conductive particles introduced into the composition of the fibers are chosen from conductive or semiconductive colloidal particles in the form of rods, small plates, spheres, strips or tubes.

The conductive colloidal particles may be chosen from:
carbon nanotubes;
metals such as gold, silver, platinum, palladium, copper, iron, zinc, titanium, tungsten, chromium, carbon, silicon, cobalt, nickel, molybdenum and metallic compounds or alloys thereof;
oxides such as: vanadium oxide (V₂O₅), ZnO, ZrO₂, WO₃, PbO , In₂O₃, MgO and Y₂O₃; and
conductive or semiconductive polymers in colloidal form.

In the case where the conductive particles are carbon nanotubes, and for filler contents less than or equal to 7%, the heating temperature is at least equal to the melting temperature of the polymer or higher.

For carbon nanotube filler contents greater than 7%, the heating temperature is at least equal to the glass transition temperature of the polymer or higher.

The invention also relates to fibers made of a composite based on conductive or semiconductive particles and on a thermoplastic polymer.

The conductive particles may be:
carbon nanotubes;
metals such as gold, silver, platinum, palladium, copper, iron, zinc, titanium, tungsten, chromium, carbon, silicon, cobalt, nickel, molybdenum and metallic compounds or alloys thereof;
oxides such as: vanadium oxide (V₂O₅), ZnO, ZrO₂,
WO₃, PbO, In₂O₃, MgO and Y₂O₃; and
conductive or semiconductive polymers in colloidal form.

In the case where the conductive particles are carbon nanotubes (CNTs), the composite based on a thermoplastic polymer and on carbon nanotubes comprises a weight content of CNTs of less than 30%, preferably of less than 20% or more preferably between 10 and 0.1%.

The heat treatment according to the invention makes it possible to obtain a composite constituting the fibers that has a volume resistivity of less than 10^{E}12 ohm.cm, preferably of less than 10^{E}8 ohm.cm, more preferably less than 10^{E}4 ohm.cm.

The thermoplastic polymer may be chosen from the group of polyamides, polyolefins, polyacetals, polyketones, polyesters or polyfluoropolymers or blends thereof and copolymers thereof.

Preferably, the composite constituting the fibers is based on a polyamide PA-6, a polyamide PA-12 or on a polyester and contains a weight content of CNTs of less than 30%.

The composite conductive fibers thus obtained may be used in the textile, electronics, mechanical or electromechanical fields.

Mention may be made, for example, of the use of conductive fibers based on a thermoplastic polymer and on carbon nanotubes, for reinforcing organic and inorganic matrices, protective clothing (gloves, helmets, etc.), in military applications, especially ballistic protection, antistatic clothing, conductive textiles, antistatic fibers and textiles, electrochemical sensors, electromechanical actuators, electromagnetic shielding applications, packaging, bags, etc.

The conductive fibers according to the present invention may in particular be used for producing strain sensors.

Other features and advantages of the invention will appear clearly on reading the description which is set out below and which is given by way of illustrative and non-limiting example and with regard to the figures in which:

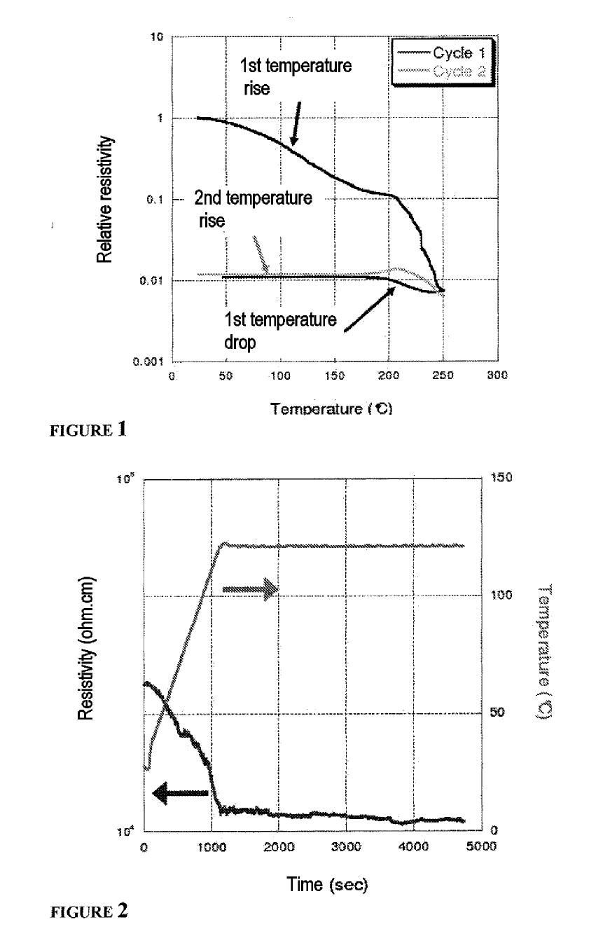

FIG. 1 represents the change in the relative resistivity of a PA6/CNT composite fiber as a function of the temperature;

FIG. 2 represents the change in the resistivity of a PA-6 fiber containing 20% of CNT during a heating cycle ranging from ambient temperature up to 120° C. at a rate of 5° C./min, followed by a hold at this temperature for one hour;

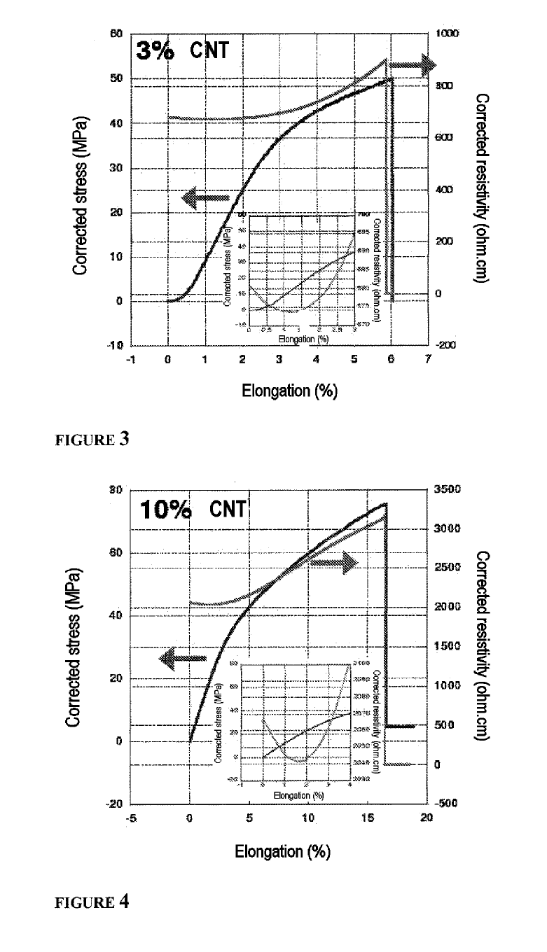

FIG. 3 shows the changes in the stress and in the resistivity of fibers comprising 3% of CNT, that are thermally treated at 250° C. at a rate of 5° C./min, as a function of the elongation; and

FIG. 4 shows the changes in the stress and in the resistivity of fibers comprising 10% of CNT, thermally treated at 250° C. at a rate of 5° C./min, as a function of the elongation.

The process described below enables the manufacture of fibers made of a composite comprising conductive or semiconductive particles and a thermoplastic polymer but other techniques may also be used.

Moreover, a material is considered in the present invention to be conductive when its volume resistivity is less than 10^{E}12 ohm.cm and insulating when its volume resistivity is greater than 10^{E}12 ohm.cm. In many applications such as the dissipation of electrostatic charges, values of less than 10^{E}8 ohm.cm are desired.

The conductive or semiconductive particles that can be used:

Among the conductive or semiconductive particles, it will be possible to choose, by way of non-limiting example:
Conductive or semiconductive colloidal particles in the form of rods, small plates, spheres, strips or tubes such as:
Metals:
Gold, silver, platinum, palladium, copper, iron, zinc, titanium, tungsten, chromium, carbon, silicon, cobalt, nickel, molybdenum and metallic compounds or alloys thereof;
Oxides:
Vanadium oxide (V₂O₅), ZnO, ZrO₂, WO₃, PbO, In₂O₃, MgO and Y₂O₃;
Conductive or semiconductive polymers in colloidal form;
Carbon nanotubes:
The carbon nanotubes that can be used in the present invention are well known and are described, for example, in Plastic World, November 1993, page 10 or else in WO 86/03455. They comprise, in a non-limiting way, those having a relatively high aspect ratio, and preferably an aspect ratio of 10 to about 1000. In addition, the carbon nanotubes that can be used in the present invention preferably have a purity of 90% or above.

### Thermoplastic Polymers:

The thermoplastic polymers that can be used in the present invention are especially all those prepared from polyamides, polyacetals, polyketones, poly-acrylics, polyolefins, polycarbonates, polystyrenes, polyesters, polyethers, polysulfones, polyfluoro-polymers, polyurethanes, polyamideimides, polyarylates, polyarylsulfones, polyethersulfones, polyarylene sulfides, polyvinyl chlorides, polyetherimides, polytetrafluoroethylenes, polyetherketones, fluoro-polymers, and also copolymers or blends thereof.

Mention may also, and more particularly, be made of: polystyrene (PS); polyolefins and more particularly polyethylene (PE) and polypropylene (PP); polyamides for example polyamide 6 (PA-6), polyamide 6,6 (PA-6,6), polyamide 11 (PA-11), polyamide 12 (PA-12); polymethyl methacrylate (PMMA); polyether terephthalate (PET); polyethersulfones (PES); polyphenylene ether (PPE); fluoropolymers such as polyvinylidene fluoride (PVDF) or VDF/HFE copolymers; polystyrene/acrylonitrile (SAN); polyether ether ketones (PEEK); polyvinyl chloride (PVC); polyurethanes, made from soft polyether blocks that are the residues of polyether diols and hard blocks (polyurethanes) that result from the reaction of at least one diisocyanate with at least one short diol; it being possible for the short diol chain extender to be chosen from the glycols mentioned earlier in the description; the polyurethane blocks and the polyether blocks being linked by bonds resulting from the reaction of the isocyanate functional groups with the OH functional groups of the polyether diol; polyester urethanes, for example those comprising diisocyanate units, units derived from amorphous polyester diols and units derived from a short diol chain extender, chosen for example from the glycols listed above; the copolyamides such as polyether-block-polyamide (PEBA) copolymers resulting from the copolycondensation of polyamide blocks having reactive end groups with polyether blocks having reactive end groups such as, amongst others: 1) polyamide blocks having diamine chain ends with polyoxyalkylene blocks having dicarboxylic chain ends; 2) polyamide blocks having dicarboxylic chain ends with polyoxyalkylene blocks having diamine chain ends obtained by cyanoethylation and hydrogenation of aliphatic α,ω-dihydroxylated polyoxyalkylene blocks known as polyether diols; and 3) polyamide blocks having dicarboxylic chain ends with polyether diols, the products obtained being, in this particular case, polyether ester amides and polyether esters.

Mention may also be made of acrylonitrile/butadiene/-styrene (ABS), acrylonitrile/ethylene-propylene/styrene (AES), methyl methacrylate/butadiene/styrene (MBS), acrylonitrile/butadiene/methyl methacrylate/styrene (ABMS) and acrylonitrile/n-butyl acrylate/styrene (AAS) polymers; modified polystyrene gums; polyethylenes, polypropylenes, polystyrenes; cellulose acetate; polyphenylene oxide, polyketone, silicone polymers, polyimides, polybenzimidazoles, elastomers of polyolefin type such as polyethylene, methyl carboxylate/polyethylene, ethylene/vinyl acetate and ethylene/ethylacrylate copolymers, chlorinated polyethylenes; elastomers of styrene type such as styrene/butadiene/styrene (SBS) block copolymers or styrene/isoprene/styrene (SIS) block copolymers, styrene/ethylene/butadiene/styrene (SEBS) block copolymers, styrene/butadiene or their hydrogenated form; elastomers of PVC, polyester, polyamide and polybutadiene type such as 1,2-polybutadiene or trans-1,4-polybutadiene; and fluoroelastomers.

This also covers the copolymers produced via controlled radical polymerization, such as, for example, the SABuS (polystyrene-co-polybutyl acrylate-co-polystyrene) and MABuM (polymethyl methacrylate-co-polybutyl acrylate-co-polymethyl methacrylate) type copolymers and all their functionalized derivatives.

The expression “thermoplastic polymer that can be used” is also understood to mean all the random, gradient or block copolymers produced from homopolymers corresponding to the above description.

In the description which follows, the examples are given for fibers comprising carbon nanotubes (CNTs) and the process for manufacturing fibers corresponds to a spinning process known to a person skilled in the art, such as a process for spinning via extrusion of a composite based on a thermoplastic polymer and on carbon nanotubes.

In accordance with the invention, the fibers may be produced either from plain (raw or washed or treated) CNTs, or from CNTs blended with a polymer powder, or from CNTs coated/blended with a polymer or other additives.

The amount of CNTs in the composite constituting the fibers is, according to the invention, less than 30%, less than 20% or more preferably between 0.1 and 10%.

The invention therefore proposes a process which makes it possible to increase the conductivity of thermoplastic composites containing CNTs, especially when the composition contains CNT contents of less than 10%.

This effect is obtained surprisingly by modifying the heat treatment step of heating the composite, this modification consisting of a gradual rise in temperature.

The invention proposes a process which makes it possible not to deteriorate, or even to improve, the conductivity of the thermoplastic composite fibers containing CNTs and that are optionally drawn, or even to render initially insulating fibers conductive.

Practically, the spinning process comprises a first step of extruding a thermoplastic polymer containing less than 30% of CNTs, optionally followed by a drawing step.

The invention consists in carrying out the heat treatment during the spinning and/or after the spinning. The heat treatment consists of a gradual increase in the temperature. Thus the conductivity of thermoplastic composite fibers containing CNTs is improved. From the various examples, it is also shown that initially insulating composite fibers can be rendered conductive via this process.

In the various examples described below, the resistivity of a thermoplastic composite fiber containing CNTs decreases during the rise in temperature and the level reached is maintained during the cooling step.

The improvement in the conductivity, by this process, is almost instantaneous. A hold for one hour at the required heating temperature does not significantly improve the level of conductivity then achieved.

The examples described below show that a heat treatment at a set temperature is not very or not at all effective, whereas a heat treatment that consists of a gradual rise in the heating temperature systematically enables an improvement in the conductivity of thermoplastic composite fibers containing CNTs, in a range from 3% to 20% of CNTs. As can be seen, under certain heating temperature and CNT filler level conditions, initially insulating fibers indeed become conductive.

The process makes it possible to manufacture conductive composite fibers, based on a thermoplastic polymer and on carbon nanotubes (CNTs) comprising a CNT content of less than 30%, preferably between 0.1% and 10%. The fibers obtained have a resistivity which is less than 10^{E}12 ohm.cm, preferably less than 10^{E}8 ohm.cm, more preferably less than 10^{E}4 ohm.cm.

The composite fibers are obtained by melt-spinning a composite based on conductive particles and on a thermoplastic polymer, as mentioned above. The diameter of the fibers obtained is between 1 and 1000 μm.

In order to obtain thinner fibers, use will be made of a technique other than melt spinning, for example electrospinning, centrifugal spinning, etc.

### EXAMPLES

The examples below relate to polyamide fibers comprising various contents of CNTs. The fibers comprising 3% and 7% of CNTs are based on AMNO TLD PA-12, and those for which the CNT content is 10% and 20% are based on Donamid® 27 PA-6. The resistances are measured using a Keithley 2000 multimeter.

### Example 1

### Process Conditions for Improving the Conductivity of Composite Fibers Based on a Thermoplastic Polymer and on CNTs, or for Rendering Initially Insulating Fibers of this Type Conductive

In this example, fibers containing various contents of CNTs are considered. They are subjected to two different heat treatments in order to demonstrate the effects of the heat treatment according to the invention in improving the conductivity of the fibers. Thus the fibers are:
Either heat treated at a set temperature: in this case, the fibers are covered at their ends with a silver lacquer, positioned flat on an aluminum sample holder and placed in an oven at the chosen annealing temperature for 30 minutes. They are then cooled and their resistance is measured at ambient temperature.
Or heat treated with a gradual rise in the temperature: in this case, the multimeter is connected to Invar rods to which the fibers are attached, the contact is provided by the silver lacquer and the whole assembly is placed in a thermal chamber controlled by a temperature controller. The heat treatment consists in gradually heating the fiber from ambient temperature up to 250° C. at a rate of 5° C./min. The fiber is then removed from the oven and cooled. During this treatment, the resistance is directly recorded continuously as a function of the temperature. It is observed that there is no notable difference between the resistance recorded at 250° C. and that recorded after the fiber has been cooled.

In both these cases, two annealing temperatures are considered, namely 120° C., temperature above the glass transition temperature of the polyamide, and 250° C., temperature above the melting temperature of the polyamide.

Table 1 below collates all of these results.

| | | | | | Heat treatment at | |
|---|---|---|---|---|---|---|
| | | | Heat treatment at | | a rate of rise of | |
| | | | set temperature | | 5° C./min | |
| | | | ρ_{120° C.} | ρ_{250° C.} | ρ_{120° C.} | ρ_{250° C.} |
| % CNT | Diameter (μm) | ρ₁ (Ω · cm) | (Ω · cm) | (Ω · cm) | (Ω · cm) | (Ω · cm) |
| 3% | 388 | — | — | — | — | 3.90 × 10³ |
| 7% | 293 | — | — | — | — | 1.00 × 10² |
| 10% | 495 | — | — | — | 2.42 × 10⁵ | 2.18 × 10³ |
| 20% | 565 | 4.30 × 10⁴ | 7.77 × 10³ | 9.01 × 10³ | 1.41 × 10⁴ | 4.84 × 10² |

This table shows the comparison of the average resistivities ρ of composite fibers based on PA containing various CNT contents, as a function of the type of heat treatment received: either a treatment of 30 minutes at set temperature, or a treatment from ambient temperature up to the annealing temperature at a rate of rise of 5° C./min. In both cases, two annealing temperatures are considered, 120° C. and 250° C., and the average is obtained from three different samples. The resistivities are measured at ambient temperature with the exception of that at 120° C. in the case of the treatment with a ramp at 5° C./min.

ρi: initial resistivity before heat treatment; : the resistance is above the detection limit.

It is observed that the annealing at set temperature does not make it possible to make fibers conductive that initially are not conductive, that is to say that contain up to 10% of CNTs. In the case of a fiber containing 20% of CNTs, which is initially conductive, the conductivity appears slightly improved by an annealing at set temperature. But the annealing temperature does not appear to have an influence, the level of conductivity achieved is not better at high temperature. It remains, furthermore, an order of magnitude below that achieved by virtue of a gradual rise in the temperature.

A heat treatment with a rate of gradual rise in the temperature of 5° C./min proves to be effective for all the composite fibers considered in a range going from 3% to 20% of CNTs. For the lowest filler contents (3% and 7%) it is necessary to reach a temperature above the melting temperature of the polymer. This heat treatment makes it possible to render fibers containing 10% of CNTs conductive, from 120° C. With a ramp of 5° C./min, this temperature is reached in only 20 minutes and the treatment is effective, whereas a treatment of 30 minutes at 250° C. is not effective.

These results clearly demonstrate the importance of the gradual rise in the annealing temperature in order to be able to provide and/or improve the conductivity of the PA/CNT composite fibers. The simple annealing at high temperature, even above the melting temperature of the polymer, proves to be a lot less effective.

### Example 2

### Typical Change in the Resistivity of a Composite Fiber Based on a Thermoplastic Polymer and on CNTs during the Heat Treatment

The example which follows relates to the typical change in the resistivity of a composite fiber based on Donamid® 27 PA-6 and on CNTs, which is initially conductive, in the course of a heat treatment ranging from ambient temperature to 250° C. at a rate of 5° C./min. A first heating cycle is carried out, then the fiber is cooled at a rate of around 2° C./min to a temperature below 50° C. A second heating cycle identical to the first is then carried out. FIG. 1 shows the typical change in the relative resistivity of a fiber as a function of the temperature during such a heat treatment. The ratio between the resistivity ρ of the fiber at the temperature in question and its resistivity ρ0 at ambient temperature is referred to as the relative resistivity (ρ/ρ0).

A large variation in the resistivity is observed during the first rise in temperature. The resistivity gradually decreases in a first stage then drops suddenly beyond 200° C., that is to say when the melting temperature of the polymer, which in the present case is 221° C., is approached. This improvement is on the whole maintained during the cooling, and the effect of the second rise in temperature is relatively limited.

### Example 3

### Effect of the Annealing Time on the Resistivity of a Composite Fiber Based on a Thermoplastic Polymer and on CNTs

In this example, the influence of the time parameter on the resistivity was observed by the applicant insofar as the latter noticed that it is the gradual increase in the temperature which makes it possible to improve the conductivity whereas up until then the heat treatment had been carried out at a set temperature.

A fiber based on Donamid® 27 PA-6 containing 20% of CNTs is placed in a thermal chamber where it is heated from ambient temperature up to 120° C. at a rate of 5° C./min, then maintained at this temperature for one hour.

The change in the resistivity recorded over time is presented in FIG. 2. This is the change in the resistivity of a PA-6 fiber containing 20% of CNTs during a heating cycle ranging from ambient temperature up to 120° C. at a rate of 5° C./min, followed by a hold at this temperature for one hour.

During the first step, while the temperature is increasing, a large decrease in the resistivity is observed as expected (see example 2). When the temperature is kept constant, it is observed, on the other hand, that the change in the resistivity is negligible. The resistivity then varies by around 7% only over one hour, whereas it varies by 56% over 20 minutes during the rise in temperature. This shows that the effect of the heat treatment on the conductivity is not only a function of the temperature, but also is almost instantaneous. This is in agreement with the relatively limited effect of a second rise in temperature demonstrated in example 2.

### Example 4

### Use of Heat-Treated Composite Fibers Based on a Thermoplastic Polymer and on CNTs as a Strain Sensor

This example shows the change in the resistivity of composite fibers annealed in situ as a function of the stretching.

The heat-treated fiber is bonded to a paper test specimen. The multimeter is connected to the fiber by two copper wires also bonded to the test specimen, and contact is provided by the silver lacquer. The fibers are scratched at a rate of 1% strain per minute and the resistance is recorded at the same time as the tensile test. It is therefore possible to deduce therefrom the change in the resistivity as a function of the elongation, making sure to correct the diameter of the fiber due to the elongation.

FIGS. 3 and 4 show the changes in the stress and in the resistivity of fibers respectively comprising 3% and 10% of CNTs, which are heat treated at 250° C. at a rate of 5° C./min, as a function of the elongation. These two quantities are “corrected”, that is to say that the variation of the cross section with the elongation has been taken into account.

The resistivity of the fiber, after a slight decrease, increases with the elongation until the fiber breaks. The variation in the electrical properties under mechanical stress consequently allows applications as strain sensors or stress sensors.

Applications and advantages of the fibers described.

The conductive fibers which have just been described allow numerous applications, in particular:

technical textiles or clothing referred to as “intelligent”, that is to say capable of responding to external stresses or of carrying out functions under certain stimulations;
textiles, composites and fibers that can be heated by the Joule effect;
antistatic textiles, composites and fibers (bags, packaging, furniture, etc.);
textiles, composites and fibers for electromechanical sensors (strain sensors or stress sensors);
textiles, composites and fibers for electromagnetic shielding;
conductive fibers and textiles for producing displays, keyboards or connectors integrated into clothes;
the production of antennae for receiving and transmitting electromagnetic waves.

Their advantage compared to existing conductive fibers:

Compared to metal fibers (copper, iron, gold, silver, metal alloys): metal fibers are difficult to weave, they have a high weight and can be degraded by corrosion. They are not very suitable for producing technical textiles or light, high-performance clothing, unlike the composite fibers according to the invention.

Compared to carbon fibers: the latter have a high electrical conductivity and a high tensile strength in the axis of the fiber. However, they lack flexibility and can only be woven by specific processes unlike the composite fibers according to the invention. Moreover, carbon fibers are not suitable for applications in which they could be subjected to large deformations (stretching, folding, knotting).

Compared to polymer fibers covered with conductive particles: fibers and textiles covered with silver particles are sold for heating textiles or antistatic bags. However, the silver deposits are expensive and have only a limited life time. The conduction properties of these fibers and textiles are degraded over time and especially after washing operations.

Compared to conductive polymer fibers: these are light and conductive. However, their poor chemical stability is an obstacle to the practical use thereof.

The composite conductive fibers according to the invention form a fifth category which by-passes the weaknesses of the fibers described previously, the table below illustrating the properties in the various cases.

| | | | Resistance to | |
|---|---|---|---|---|
| | | Chemical | washing and to | Flexibility |
| Conductive fibers | Weight | stability | surface attacks | deformability |
| Metal | − | − | + | − |
| Carbon | + | + | + | − |
| Metallic deposits | + | − | − | + |
| on polymer fibers | | | | |
| (example: silver | | | | |
| particles) | | | | |
| Conductive | + | − | − | + |
| polymers | | | | |
| Conductive fibers | + | + | + | + |
| according to the | | | | |
| invention | | | | |

1. A process for manufacturing fibers made of a composite based on a thermoplastic polymer and on conductive or semiconductive particles, comprising a heat treatment, said heat treatment consisting of heating the composite produced with a gradual rise in the temperature.

2. The process for manufacturing fibers as claimed in claim 1, wherein the gradual rise in temperature is achieved by a ramp preferably of less than 50° C. per minute.

3. The process for manufacturing fibers as claimed in claim 2, wherein the gradual rise is achieved by a ramp of 5° C. per minute.

4. The process for manufacturing fibers as claimed in claim 1, wherein the maximum heating temperature is greater than or equal to the glass transition temperature of the thermoplastic polymer.

5. The process for manufacturing fibers as claimed in claim 1, wherein the maximum heating temperature is less than or equal to a temperature greater than or equal to the melting temperature of the thermoplastic polymer.

6. The process for manufacturing fibers as claimed in claim 1, wherein the conductive or semiconductive particles are chosen from conductive or semiconductive colloidal particles in the form of rods, small plates, spheres, strips or tubes.

7. The process for manufacturing fibers as claimed in claim 6, wherein the conductive or semiconductive colloidal particles are chosen from:
carbon nanotubes;
gold, silver, platinum, palladium, copper, iron, zinc, titanium, tungsten, chromium, carbon, silicon, cobalt, nickel, molybdenum and metallic compounds or alloys thereof;
vanadium oxide (V₂O₅), ZnO, ZrO₂, WO₃, PbO, In₂O₃, MgO and Y₂O₃; and
conductive or semiconductive polymers in colloidal form.

8. The process for manufacturing fibers as claimed in claim 1, characterized in that wherein the thermoplastic polymer is chosen from the group of polyamides, polyolefins, polyacetals, polyketones, polyesters or polyfluoropolymers or blends thereof and copolymers thereof.

9. The process for manufacturing fibers as claimed in claim 7, wherein the conductive particles are carbon nanotubes, the composite based on a thermoplastic polymer and on carbon nanotubes comprises a weight content of CNTs of less than 30% wherein the composite constituting the fibers has a volume resistivity of less than 10^{E}12 ohm.cm.

10. The process for manufacturing fibers as claimed in claim 9, wherein the weight content of the carbon nanotubes is less than or equal to 7%, and the heating temperature is at least equal to the melting temperature of the polymer or higher.

11. The process for manufacturing fibers as claimed in claim 9, wherein the carbon nanotube weight content is greater than 7%, and the heating temperature is at least equal to the glass transition temperature of the polymer or higher.

12. The process for manufacturing fibers as claimed in claim 1, wherein the process comprises a melt-spinning step, wherein the heat treatment is carried out on the composite during the spinning and/or after spinning.

13. Conductive fibers obtained by the process as claimed in claim 1, wherein the conductive fibers comprise a composite based on a thermoplastic polymer and on conductive or semiconductive particles wherein the volume resistivity of the composite is less than 10^{E}12 ohm.cm.

14. The conductive fibers as claimed in claim 13, wherein the conductive or semiconductive particles are chosen from conductive or semiconductive colloidal particles in the form of rods, small plates, spheres, strips or tubes.

15. The conductive fibers as claimed in claim 14, wherein the conductive fibers comprise conductive or semiconductive colloidal particles chosen from:
carbon nanotubes;
gold, silver, platinum, palladium, copper, iron, zinc, titanium, tungsten, chromium, carbon, silicon, cobalt, nickel, molybdenum and metallic compounds or alloys thereof;
vanadium oxide (V₂O₅), ZnO, ZrO₂, WO₃, PbO, In₂O₃, MgO and Y₂O₃; and
conductive or semiconductive polymers in colloidal form.

16. The conductive fibers as claimed in claim 15, wherein the conductive fibers comprise carbon nanotubes, the weight content of carbon nanotubes being less than 30%.

17. The conductive fibers as claimed in claim 13, wherein the conductive fibers comprise a thermoplastic polymer chosen from the group of polyamides, polyolefins, polyacetals, polyketones, polyesters or polyfluoropolymers or blends thereof and copolymers thereof.

18. The conductive fibers as claimed in claim 16, wherein the conductive fibers comprise a polyamide and carbon nanotubes.

19. An article selected from the group of textiles, electronic components, mechanical components and electromechanical components, the article comprising the conductive fibers as claimed in claim 13.

20. A method of reinforcing the mechanical properties of an article selected from the group of organic and inorganic matrices, protective clothing (gloves, helmets, etc.), in ballistic protection devices, antistatic clothing, conductive textiles, antistatic fibers and textiles, electrochemical sensors, electromechanical actuators, electromagnetic shielding applications, packaging and bags, the method comprising incorporating the conductive fibers of claim 13 into the article.

21. The method as claimed in claim 20, wherein the article is a strain sensor.
